(19) United States
(12) Patent Application Publication
(10) Pub. No.: US 2009/0142734 A1
(43) Pub. Date: Jun. 4, 2009

(54) Cosmetic accessory device for teeth

(76) Inventor: Nancy M. Albert, Grovetown, GA (US)

Correspondence Address: Kenneth Buffington, 4434 Columbia Rd., #100, Martinez, GA, 30907, US

(21) Appl. No.: 11/998,498

(22) Filed: Nov. 30, 2007

(51) Int. Cl. A61C 13/08

(52) U.S. Cl. 433/201.1

(57) ABSTRACT

An improved cosmetic accessory device for teeth that simulates the appearance of an assemblage of teeth and gum. The device includes a gum portion and a tooth portion shaped and dimensioned to cover the user's upper or lower front teeth. The device is made of a nontoxic, nonirritating, tasteless, odorless, resilient, easily cleaned and chemically stable material that does not stick to natural teeth, gums, or most dental work. In use, the device is held in place by custom-fitted inner projections that match the spaces between the user's own front teeth. Optionally, a shelf extending just across the front teeth and extra fitting material placed in spaces where there are missing teeth provides additional security in holding the device in place. The device may be refitted as necessary by simply partially submerging the device in hot water. Unlike typical conventional novelty dental devices, the natural teeth and gums are not completely covered and there is no protrusion into the mouth cavity, so the device is comfortable to wear and does not interfere with natural speech or bite closure.

### FEDERALLY SPONSORED RESEARCH

Not Applicable.

### SEQUENCE LISTING OR PROGRAM

Not Applicable.

### BACKGROUND

1. Field of Invention

The present invention relates to cosmetic accessory devices. In particular, the present invention relates to a removable cosmetic accessory device that is worn to enhance the user's appearance, and a method and kit for making and fitting the device.

2. Prior Art

Cosmetic dental devices are typically worn over a user's natural dentition for an improvement in the appearance of a user's teeth, mouth and smile. These dental devices serve as an inexpensive way to dramatically improve the user's smile, at least temporarily. New dental materials have revolutionized dentistry. It is now possible to replace missing teeth with a functional denture that so closely resembles natural teeth and gums that only the user knows he is wearing a prosthesis rather than “the real thing.”

U.S. Pat. No. 6,652,275 to Byers teaches an intraoral article that is user customized from a contoured, thermoplastic preform whereby the materials consist of ethylene vinyl acetate and polycaprolactone.

U.S. Pat. No. 6,491,521 to Fowler shows a formable mouthguard with teeth made from pliable materials.

U.S. Pat. No. 6,450,814 to Brittain teaches a novelty teeth assembly includes a retainer sized for fitting over at least a portion of a wearer's dentition and an artificial tooth secured to the retainer and extending outward.

U.S. Pat. No. 5,324,198 to Hazen teaches a denture covering existing teeth and gums, a device which includes two separate impression-molded all gum and cap-cup encasements (upper and lower arches) with veneered artificial teeth mounted to the encasement walls.

U.S. Pat. No. 5,083,770 to Holland shows a device that includes fangs and a bladder with discharge ports. Users can compress the bladder with their tongues to discharge simulated blood from apertures near the tips of the fangs.

All of these devices either surround the user's own teeth and gums, or have wires or other supports that obtrude into the user's mouth. Such devices are frequently difficult to fit, uncomfortable to wear, and interfere with the user's normal speech patterns.

In U.S. patent application Ser. No. 08/510,005, filed Aug. 1, 1995, Albert discloses a dental disguise device that simulates the appearance of an assemblage of teeth and gums. This entertainment device, which covers the user's upper front teeth and gums, is made of a nontoxic, chemically stable material that does not stick to natural teeth and gums, or indeed to most dental work. In use, the device is held in place by the springiness of the material and by inner projections that fit into the spaces between the user's own front teeth. No material extends around or behind the user's natural teeth and gums, thus, the device is relatively comfortable to wear and does not interfere with natural speech or bite closure. The device, which can be custom-fitted by the user, is made in several sizes to accommodate the range of upper jaw sizes found in adults.

In U.S. Pat. No. 5,951,291 to Albert et. al., Albert discloses a cosmetic tooth and gum device for covering the user's upper front teeth and gums by mixing a base and catalyst of a room-temperature-curable silicone as the fitting material. No material extends around or behind the user's natural teeth and gums. The device is held in place primarily by inner projections that fit into the spaces between the user's own front teeth.

Modern dentistry can accomplish seeming miracles for those patients who can afford to pay the price, but offers little for many others who would like to have better looking teeth without the time, discomfort, and expense associated with extensive dental work. Despite the wide variety of restorative dental techniques and cosmetic dental devices available to consumers, there is no known dental device that is inexpensive, easy to fit and wear, and readily adaptable to both entertainment and cosmetic purposes. Fitting typical, presently available devices requires a multistep, iterative process which can be difficult for persons with limited manual dexterity. In addition, many consumers find it difficult or uncomfortable to make an impression of their own natural teeth for fitting purposes.

There is a need for a dental accessory device made of nontoxic and nonirritating materials, that can accommodate a variety of dental conditions, and that can be worn over the user's own upper front teeth and gums to enhance his or her appearance. Such a device could be worn whenever the user wished to enhance his or her appearance. It should be simple and easy to fit, easy to refit, comfortable to wear, difficult to detect, and allow the user to speak and drink normally. The availability of a suitable cosmetic accessory that could be worn whenever the user wished to feel more confident about his or her appearance, and to appear more attractive is a needed addition to the array of cosmetic products.

### SUMMARY OF THE INVENTION

According to its major aspects and broadly stated, the present invention is a removable cosmetic accessory device that simulates the appearance of an assemblage of teeth and gums. The present invention is an improvement over the cosmetic accessory device for teeth which was granted to Albert et al in U.S. Pat. No. 5,951,291. The present device includes a gum portion and a tooth portion which is shaped and dimensioned to cover the user's front teeth and at least a portion of the gums. To enhance the user's appearance, the tooth portion is preferably shaped to resemble attractive natural teeth. However, if desired, the tooth portion may simulate the appearance of unsightly teeth for a convincing theatrical disguise. In a preferred embodiment of the invention, the device is in the form of a somewhat flexible shell that is custom fitted to an individual user with a room-temperature-curable polymer material.

An important feature of the present invention is the method for custom fitting the accessory device to an individual user. The device is fitted by coating at least part of its interior surface with a room-temperature-curable polymer material, heating said polymer to the melting point and then pressing it firmly against the user's front teeth, with the coating engaging the teeth, until the material is at least partly cured (if desired, a thin ledge or shelf of the polymer material may be formed just across the cutting edges of the front teeth). The device is then removed from the user's mouth and trimmed of any excess material that might interfere with the user's comfort during wear. If the fit is uncomfortable to the user, the polymer material may be remelted and refitted to the user's front teeth. Optionally, any excess polymer material may be used to fill in areas of missing teeth.

In a preferred embodiment of the invention, the fitted device is a thin, somewhat resilient and somewhat flexible shell with an approximately semicircular cross section. When properly fitted for wearing its inner layer surface, which is molded to match the user's dentition, mechanically holds the device in place in the user's mouth. Unlike conventional dentures and dental accessories, a device according to the invention covers only the labial surfaces of the user's natural teeth and gums, so it is comfortable to wear and does not interfere with natural speech or bite closure.

Another important feature of the present invention is the selection of materials used for making the device. The device is made of nontoxic, somewhat resilient, chemically stable materials that are tasteless, odorless, easily cleaned, and do not stick to natural teeth, gums, or most dental work (fillings, crowns, bridges, etc.). Preferably, the device is made of two portions of a similar material which are fused together to form an outer labial shell which is then attached to a thin fitting portion of material which is made of a workable thermoplastic resin. The outer labial shell is made of a thermoplastic polyurethane (TPU). The materials are medical or food grade approved, and have high tear strengths. In addition, extra thermoplastic resin fitting material is provided in an envelope for the user to fuse extra material into spaces where teeth are missing to serve as a fastener and spacer. Additionally, the extra fitting material will stiffen the device where two or more adjacent teeth are missing. A wide range of materials with the requisite properties are broadly suitable for use with the invention. Preferably, the fitting portion of the device is should be stiffer (more rigid) and possess a higher flexural modulus than the outer labial shell materials so that different arch sizes can be fitted.

Another feature of the present invention is the fitting portion of the device, which serves to maintain the position of the device in use. The fitting portion includes custom fitted matching surfaces, or imprints of the user's teeth. Optionally, the inner lingual surface of the outer labial shell is provided with a ledge or shelf which maintains the device's position during normal wear but is generally concealed from view. The tooth portion is dimensioned to cover the upper front teeth, preferably those teeth that are most visible when the wearer smiles (the incisors and canines, and preferably also the first premolars, i.e., the premolars immediately adjacent to the canines). Depending on the cosmetic appearance of the tooth portion, the device may be worn as an accessory to enhance the user's appearance and foster increased self-esteem, as an amusing disguise to entertain the user and others, as a theatrical accessory, or as a teaching tool to demonstrate the results of planned dental treatment.

If desired, the tooth portion may include fashionable decorations such as simulated gold crowns, metallic or precious stone insets, and like decorations. In this embodiment, the device is worn as an accessory, for example, as a cost effective device for concealing unattractive teeth, to camouflage dental braces for a special occasion, or to show the projected results of recommended dental treatment. Alternatively, the tooth portion of the device may be decorated to resemble unattractive teeth.

There are significant improvements of the present invention over the previous invention disclosed by Albert et. al. in U.S. Pat. No. 5,951,291. The user can simply place the device in hot water and refit again that if the first fit is not comfortable. This is because the cured thermoplastic polymer material used in the present invention allows refitting whereas the cured silicone used in the previous invention could not be refitted after curing to room temperature. There is no silicone used in the present invention. Another improvement over the previous invention is the ability to fuse extra fitting material into the inner or fitting layer to make projections into areas where teeth are missing. The extra fitting material functions as a spacer (keeps neighboring teeth from shifting) as well as acting as male snap type fastener to increase the security of the fit. This could not be done with the previous invention due to the properties of silicone.

Other features and advantages of the present invention will be apparent to those skilled in the art from a careful reading of the Detailed Description of a Preferred Embodiment presented below and accompanied by the drawings.

### BRIEF DESCRIPTION OF THE DRAWINGS

FIG. 1A is a perspective view of a dental accessory device according to a preferred embodiment of the present invention;

FIG. 1B is a perspective view of another dental accessory device according to the invention;

FIG. 2 shows the device of FIG. 1A worn by a user;

FIG. 3A is a cross-sectional view of the device of FIG. 1, taken through the lines 3A-3A of FIG. 1;

FIG. 3B is a cross-sectional view of the device of FIG. 3A, after the device has been custom-fitted to an individual user;

FIG. 3C is a cross-sectional view of the device of FIG. 3A after fitting, taken through the lines 3C-3C of FIG. 3A;

FIG. 4 is a flow chart illustrating a method for custom-fitting the device of FIG. 1 to a individual user;

FIG. 5 shows a kit for custom-fitting the device of FIG. 1 to an individual user, and

FIG. 6 shows a perspective view of a dental accessory device fitted on a maxillary arch to illustrate how the fitting material fills in the areas where teeth are missing.

### DETAILED DESCRIPTION

### Preferred Embodiment

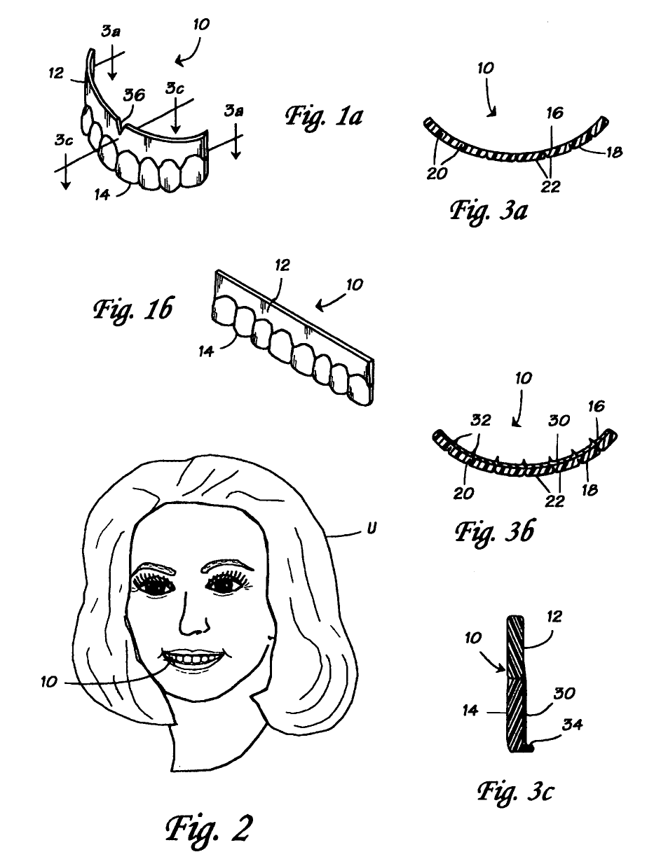

With reference now to the drawings, and in particular to FIGS. 1-6 thereof, the device, as generally designated by the reference numeral 10, will be described.

A preferred embodiment of the present invention, as shown in FIG. 1A, is a bilayered accessory device 10 simulating the appearance of an assemblage of teeth and gums with a gum portion 12 and tooth portion 14. When fitted to an individual user and worn over his or her own upper front teeth and gum, accessory device 10 covers the teeth that are most visible when the user smiles. Preferably, device 10 is dimensioned to cover at least the six center front teeth (the upper incisors and canines); more preferably, at least eight center front teeth. Device 10 may be approximately rectilinear (FIG. 1B) which readily adapts to the curvature of the user's teeth. Device 10 as illustrated in FIGS. 1A and 1B is a maxillary or upper dental device; however, it will be appreciated that the following description is equally applicable to a mandibular dental device that covers the lower front teeth and gums, except such a device would prevent bite closure.

In accordance with a preferred embodiment of the present invention, tooth portion 14 of accessory device 10 is shaped to simulate attractive natural teeth (device 10 is shown worn by a user U in FIG. 2). While it is believed that most users prefer a device that resembles natural, unadorned teeth, device 10 may be embellished with fashionable decorations such as simulated gold crowns, gold insets or precious stone insets if desired. Alternatively, device 10 may include simulated cavities, fissures, sores and the like. Thus, device 10 may be used as a cosmetic or therapeutic accessory to enhance the user's appearance and self-esteem, as an amusing disguise or theatrical accessory to give the user the appearance of teeth different from his or her own, as an educational tool to teach children the value of good dental hygiene and the consequences of poor hygiene, or as an accessory to illustrate the results of planned dental treatment.

Before fitting, the bilayered device 10 is an outer labial shell attached to a thin fitting portion of material. The outer labial shell consists of either a thin arched shape or a nearly flat rectilinear shape. The outer labial shell has an approximately smooth inner lingual surface 16 and an outer labial surface 18 (FIG. 3A). The thin fitting portion 30 interfaces the outer labial shell along the inner lingual surface 16. Labial surface 18 preferably has a plurality of indentations 20 that delineate individual “teeth” 22. The gum portion 12 and teeth portion 22 of the labial surface is colored to resemble natural gum tissue and teeth respectively, by incorporating a suitable coloring agent into the material of gum portion 12 and teeth portion 22. Alternately, gum portion 12 and teeth portion 22 may be painted, dyed or colored with some other convenient technique after manufacture of device 10.

After fitting to an individual user, accessory device 10 is a thin, arch shaped preferably no more than approximately 1-3 mm thick. The inner surface 16 is at least partly covered by a thin portion 30 of fitting material that forms projections 32 that fit into the spaces between the user's teeth (FIG. 3B) and, optionally, an inwardly projecting ledge or shelf 34 that helps maintain the position of the device 10 during wear. If there are any natural teeth missing, the user may apply any extra fitting material 30 (FIG. 6) to fill the empty space between the missing teeth to additionally aid in securing the device in position during wear.

Device 10 is made of any nontoxic, nonirritating, tasteless, odorless material (or combination of materials) that has sufficient structural and mechanical integrity to maintain its shape and secure the device in place during normal activities such as speaking, laughing, drinking, and so forth. The materials are chemically stable and easy to clean, and somewhat flexible and resilient to minimize irritation to the user's mouth and enable the user to take off and put on the device. In addition, the materials does not stick to natural teeth, gums, or most dental work such as fillings, inlays, crowns and bridges, bondings and the like. To permit custom fitting device 10 to an individual user, the preferred material is firm at and below body temperature. The field of dentistry teaches a variety of suitable food or medical grade materials from which one can make the device including polyesters, alkyd resins and acrylic polymers.

In the present invention, the bilayered device 10 consists of an outer labial shall and a thin fitting layer 30. The outer labial shell is made in two layers, a tooth portion 14 and a gum portion 12. Typically, these two layers are of similar materials. The thin fitting layer 30 is a different type of material which possesses good properties for impressioning. The tooth portion 14 and gum portion 12 are each made separately and the two portions are fused together by an adhesive or overlay technique to form the outer labial shell. The fitting layer 30 is attached to the inner surface of the outer labial shell by heating in the oven to form the final bilayered device 10. The fitting layer 30 has characteristics that permit impressioning of the user's teeth and gum, and its high tensile strength maintains its shape. Pressing the inner fitting layer 30 onto the user's natural teeth forms projections 32 that aids in securing the device 10 in position. The softening temperature of the outer labial shell is higher than the inner fitting layer 30. The fitting inner layer 30 cures at temperatures significantly less than the outer labial shell.

Elongation, hardness and flexibility are important material properties since the device must be stretched or spread out to be placed on or off the user's natural dentition. All materials should have properties suitable for injection molding. Preferably, the outer labial shell materials and fitting portion materials should have elongations when cured (room temperature) greater than or equal to approximately 400% and 600% respectively. Preferably, the fitting portion 30 should be the hardest material and typically the fitting portion 30 has a durometer hardness ranging between approximately 80 to 95 Shore A. The material of tooth portion 14 should be the least hardest material and typically the tooth portion 14 has a durometer hardness ranging between approximately 75-90 Shore A. Flexural properties are important in assessing the resistance of materials to bending such that a higher flexural modulus is characteristic of a stiffer material. Preferably, the fitting portion material 30 should be stiffer (more rigid) and possess a higher flexural modulus than the outer labial shell materials. While materials with the aforementioned properties are preferred, materials having an elongation, hardness and flexural modulus outside these dimensions may also be suitable for the practice of the invention.

For example, the bilayered device 10 was shaped and dimensioned for wearing over the user's upper front teeth. First, the inner fitting portion 30 was die cut in this example, but could have been injection molded. The fitting portion 30 was made using polycaprolactone (PCL) which is a biodegradable thermoplastic polymer type plastic. PCL has a low melting-point and low viscosity, and it is easy to process. PCL melts from 120° F. to 170° F. depending on the environmental conditions. Second, the outer labial shell consisting of a tooth portion 14 and a gum 12 portion were injection molded using an overlay method. The tooth portion 14 and the gum portion 12 of the outer labial shell were made of a thermoplastic polyurethane (TPU) resin which softened at approximately 203° F. Other TPU resins with softening points between 196-392° F. are equally suitable for this application. It was necessary to heat the tooth portion 14 and gum portion 12 to 250-270° F. in order to fuse the materials together to form the outer labial shell. Next, the outer labial shell and fitting portion were attached together by baking them in the oven at 260° F. for approximately 5 minutes and 30 seconds. The resulting bilayered device resembling natural teeth was fitted to a user. The fitting material was PCL, the same material used to make the fitting layer 30. Typically the human mouth can withstand temperatures up to 180° F., and the PCL melts and cures below this temperature. A satisfactory fit was achieved, with projections 32, anchors 24 and a shelf 34 that helped maintain the position of the device 10 during use.

Device 10 may be manufactured by any suitable technique, including molding, stamping, casting and the like. As noted above, the outer labial shell was injection molded using an overlay method, and the tooth portion 14 and gum portion 12 were both made of TPU. Because tooth portion 14 and gum portion 12 were made of similar materials, the overlay injection molding process bonds the two portions. The device is preferably manufactured with gum portion 12 and teeth 14 being made of pigmented materials to resemble natural gums and teeth, respectively. The pigments were mixed into the raw materials before molding. However, gum portions 12 and teeth 14 could be colored with suitable paints or dyes that are nontoxic and chemically stable.

An improvement of the present invention over the invention disclosed by Albert et. al. in U.S. Pat. No. 5,951,291 is that if the fit is not comfortable, the user can simply place the device in hot water and refit again due to the properties of the PCL material. The previous invention used silicone as the primary filling material which could not be refitted after curing to room temperature. In addition, silicone has undesirable properties such as poor abrasion resistance, tensile strength and poor flex fatigue. In the present invention, there is no silicone, the PCL and TPU materials overcome the disadvantages of silicone.

It is known in the art that the range of individual variations in the size of the adult human mouth and teeth is relatively small. For example, the lateral spacing between the rear molars is approximately 2 inches. Therefore, an accessory device according to the present invention can be made in a range of sizes to cover the expected range of variations commonly found in the adult human mouth, and if desired, smaller sizes may be made for children. Preferably, however, the device is made in a single size that fits substantially all adults, and fitted in a manner to be described below.

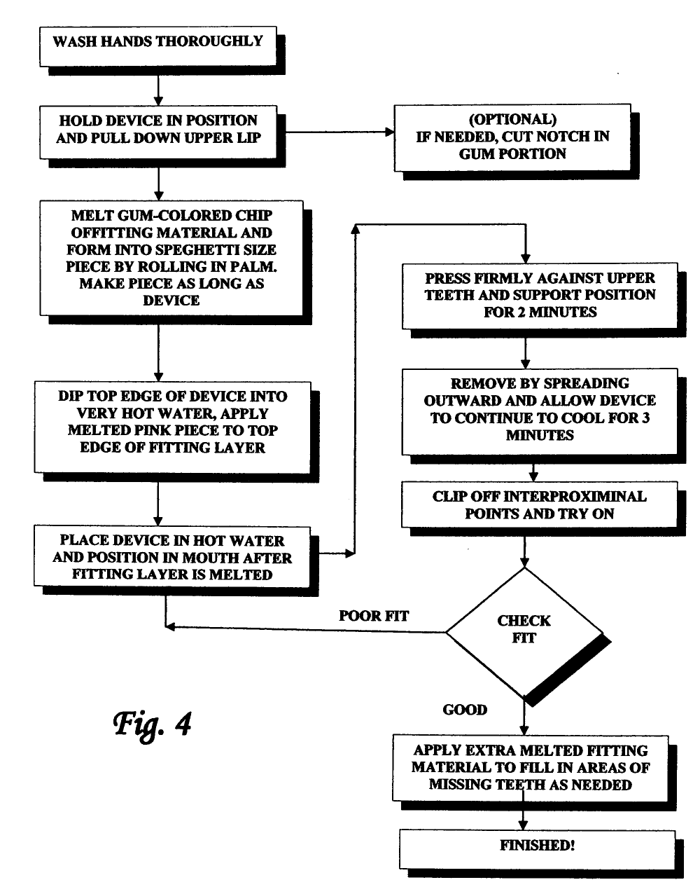

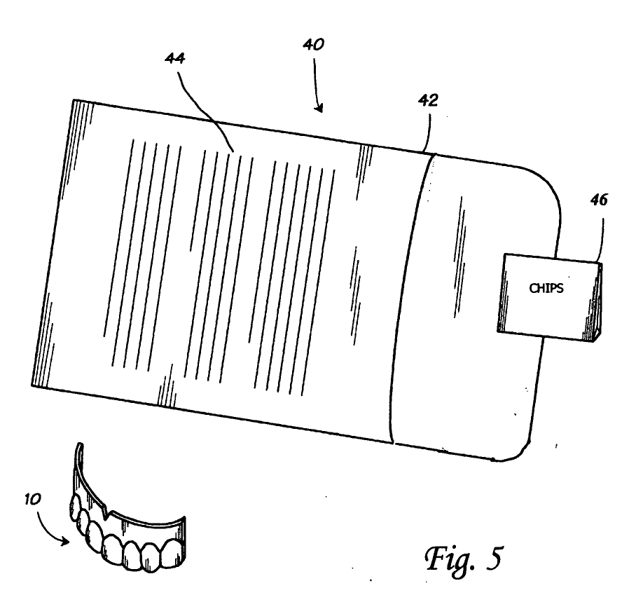

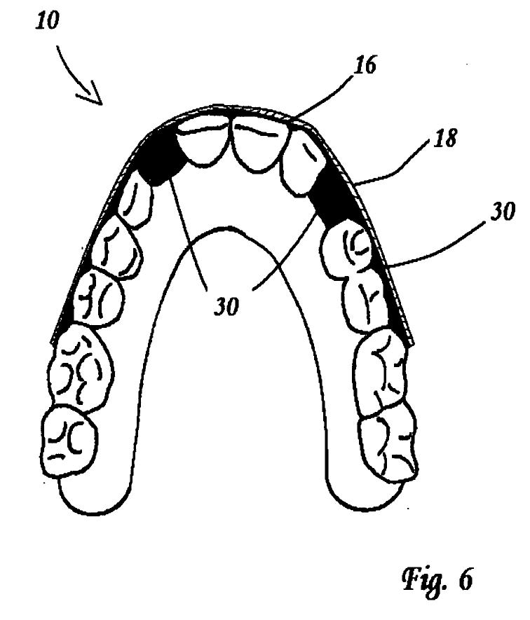

Referring now to FIG. 4, there is shown a method for fitting device 10 to an individual user. As shown in FIGS. 1A and 1B, device 10 is supplied in the form of a shell bearing the outlines of several front teeth. Note that device 10 is shown as an accessory for the user's upper front teeth; however, it will be understood that device 10 may readily be shaped and dimensioned for covering the lower front teeth. The device may be supplied in kit form 40 (FIG. 5), with a container 42, fitting instructions 44, a device 10, and envelope 46 that contains the fitting material 30.

The user proceeds to custom-fit device 10 to his or her mouth as follows:
1. Wash hands thoroughly.
2. Determine the preferred placement of device 10 in the mouth. With device in proper position pull down on center of upper lip to determine if device needs trimming to be comfortable. Remove device 10 from the mouth. If needed, cut a small notch 36 into gum portion 12 (FIG. 1A). Notch 36 accommodates the frenum (a small web of connective tissue that extends between the gum and the upper lip) that may otherwise, in some users, interfere with the proper placement of device 10. Device 36 may, of course, be supplied with a pre-cut notch 36, positioned generally as indicated in FIG. 1A.
3. Open envelope 46, and remove the gum colored chip.
4. Melt the gum colored chips of fitting material 30 in very hot water and form into a spaghetti size piece as long as the entire length of the device 10 by rolling the fitting material 30 in the palm of hand. Set aside envelope 46 with the remaining fitting material 30.
5. Dip the top edge of the device 10 into very hot water and apply spaghetti size piece of pink fitting material 30 to top edge of inner lingual surface 16 of device.
6. Submerge entire device 10 in hot water and position in mouth after inner lingual layer 16 is melted. While looking in a mirror, firmly push device 10 straight into position against the upper front teeth and gums, with fitting material 30 on the inside (i.e., contacting the natural teeth and gums). Do not bite into fitting material 30. Push inner surface 16 of device 10 (covered with fitting material 30) against the teeth and gums, making sure that the device is properly positioned and hold in place for 2 minutes for cooling.
7. Remove the device 10 by spreading it outward and allow the device to continue to cool for 3 minutes.
8. Trim away any excess fitting material 30, including any interproximinal points and any other points that impede the natural bite. Retain some projections (i.e., projections 32, FIG. 3B), since these are necessary to hold device 10 in place during use.
9. Place device back in mouth to check the fit. If the fit is acceptable, device 10 is finished and ready for use. If the fit is uncomfortable, repeat steps 6-9.

Device 10 is preferably furnished in a size that can readily be fitted to the vast majority of adults and, indeed, to many older children as well. For users with somewhat smaller-than-average jaws, a portion of device 10 with one or more of the “teeth” may be cut off so as to help achieve a better fit. Alternatively, device 10 can be made in a range of sizes.

As noted above, device 10 is made of materials that do not stick to natural teeth or most dental work. However, the device and/or fitting material 30 may mechanically surround or adhere to dental braces, exposed wires of partial dentures, and similar items when softened. When fitting device 10 to an individual who wears braces or other dental appliances with exposed wires, it is preferable to cover and round off the wires with removable wax before placing the device over the teeth. It will be evident to those skilled in the art that device 10 is best used only by those with reasonably good oral health.

In use, a fitted accessory device 10 is worn engaging the upper front teeth so that projections 32 fit into the spaces between the user's natural teeth and shelf 34 (if present) is just under the teeth. As best seen in FIG. 3B, device 10 is approximately semicircular in cross section after fitting. Thus, custom fitted projections 32, missing tooth anchors 24 and shelf 34 hold device 10 in place in the user's mouth. Or the fitted device 10 can be described as having imprints that match the user's teeth and is held in place by the mechanics of matching surfaces. Unlike conventional dental accessories, the natural teeth and gums are not fully covered, so device 10 is comfortable to wear and does not interfere substantially with natural speech or bite closure. Also, unlike other conventional dental accessories, neither the device nor the fitting material protrudes into the mouth cavity. The user is able to speak, laugh, open and close his mouth, and drink normally while wearing the device.

It will be apparent to those skilled in the art that many changes and substitutions can be made to the preferred embodiment herein described without departing from the spirit and scope of the present invention as defined by the appended claims.

What is claimed is:

1. A cosmetic accessory device, comprising:
a first portion having an outer surface shaped to resemble an assemblage of front teeth, said first portion including a tooth portion made of a first somewhat resilient material;
a second portion having an outer surface shaped to resemble a gum, made of a second material similar to said first material;
an outer labial shell formed by attaching said first portion and said second portion together; and
a third portion adapted for attachment to the innermost surface of said outer labial shell and fitting said device to a user, said third portion made of a room-temperature-curable material.

2. The device as recited in claim 1, wherein said first portion, second portion and third portion materials are selected from the group consisting of medical grade and food grade materials.

3. The device as recited in claim 1, wherein said first and second materials are selected from the group consisting of curable thermoplastic polyurethane (TPU) materials.

4. The device as recited in claim 1, wherein said room-temperature-curable material is selected from the group consisting of curable polycaprolactone (PCL) materials.

5. The device as recited in claim 1, wherein said first portion has a hardness of at least 75-90 Shore A, said second portion has a hardness of at 75-90 Shore A, and said third portion has a hardness of 80-95 Shore A.

6. The device as recited in claim 1, wherein said third portion has a flexural modulus at least approximately five times the flexural modulus of said first portion.

7. The device as recited in claim 3, wherein said first and second materials have elongations at least approximately equal to 400%.

8. The device as recited in claim 4, wherein said room-temperature-curable material has an elongation at least approximately equal to 600%.

9. The device as recited in claim 1, wherein extra said room-temperature-curable material is applied between said user's front teeth and said inner fitting layer for additional support in holding the device securely in position.

10. The device as recited in claim 1, wherein extra said room-temperature-curable material is applied in the vacant spaces between the said user's missing teeth to enhance the fit by functioning as a male portion of a mechanical fastening device.

11. The device as recited in claim 1, wherein extra said room-temperature-curable material is applied in the vacant spaces between the said user's missing teeth to serve as a spacer to keep teeth from shifting.

12. The device as recited in claim 1, wherein said outer labial shell is made by a process comprising the steps of:
molding said first material to form tooth material;
placing said tooth material into a second mold with a gum cavity;
injecting said second material into said second mold; and
bonding first and second material to make an outer labial shell.

13. The process as recited in claim 12, wherein said outer labial shell is made by simultaneously injecting said first and second materials into a single mold.

14. A method for making a cosmetic dental device, said method comprising the steps of:
coloring said first or tooth portion to resemble natural teeth;
molding a tooth portion of a first material, said tooth portion having an outer surface shaped to resemble a plurality of front teeth;
coloring said gum or second portion to resemble natural gum;
molding a gum portion of a second material, said gum portion having an outer surface shaped to resemble natural gums;
attaching said tooth portion to said gum portion to make an outer labial shell;
die cutting or injection molding a said third or room-temperature-curable material to make an inner fitting layer;
attaching said outer labial shell to said inner fitting layer to make a bilayered shell;
said tooth portion and said gum portion being made of somewhat flexible materials so that said device is capable of fitting to an individual user by melting the inner layer of said bilayered shell, positioning said bilayered shell so that said inner fitting layer engages at least six front teeth of a user, pressing said bilayered shell with said third material against user's natural front teeth until said third material cures, removing said bilayered shell with said cured third material from user's natural front teeth, and trimming excess cured said third material from said bilayered shell.

15. The method as recited in claim 14, wherein the said first and second portions are painted to resemble natural teeth and gums respectively.

16. The method as recited in claim 14, wherein said making step further comprises molding said outer labial shell by simultaneously injecting said first and second materials into a single mold.

17. The method as recited in claim 14, wherein said bilayered shell and said third material are materials selected from the group consisting of medical grade and food grade materials.

18. The method as recited in claim 14, wherein said tooth portion has a hardness of at least 75-90 Shore A, said gum portion has a hardness of at 75-90 Shore A, and said room-temperature-curable material has a hardness of 80-95 Shore A.

19. The method as recited in claim 14, wherein said third portion has a flexural modulus at least approximately five times the flexural modulus of said first material.

20. The method as recited in claim 14, wherein said first and second materials have elongations at least approximately equal to 400%.

21. The method as recited in claim 14, wherein said room-temperature-curable material has an elongation at least approximately equal to 600%.

22. The method as recited in claim 14, wherein extra said room-temperature-curable material is applied between said user's front teeth and said inner fitting layer for additional support in holding the device securely in position.

23. The method as recited in claim 14, wherein extra said room-temperature-curable material is applied in the vacant spaces between the said user's missing teeth to enhance the fit by functioning as a male portion of a mechanical fastening device.

24. The method as recited in claim 14, wherein extra said room-temperature-curable material is applied in the vacant spaces between the said user's missing teeth to serve as a spacer to keep teeth from shifting.

25. A kit for making a cosmetic dental device for a user, said kit comprising:
an outer labial shell having an outer surface shaped to resemble an assemblage of front teeth, said outer labial shell being made of a nontoxic, nonirritating, somewhat flexible material, said outer labial shell including a tooth portion made of a first material and a gum portion made of a second material;
a room-temperature-curable material adapted for attachment to the inner surface of said outer labial shell, so that said device can be fitted to said user by melting said room-temperature-curable material or inner fitting layer, positioning said shell so that said room-temperature-curable material engages at least some of the front teeth of said user, pressing said shell with said room-temperature-curable material against said front teeth until said room-temperature-curable material cures, and removing said shell with said cured material from said front teeth;
instructions for fitting said device to said user;
an envelope containing extra said room-temperature-curable material; and
a container for holding said outer labial shell, said instructions, and said envelope.

26. The kit as recited in claim 25, wherein said bilayered shell and said third material are materials selected from the group consisting of medical grade and food grade materials.

27. The kit as recited in claim 25, wherein said tooth portion has a hardness of at least 75-90 Shore A, said gum portion has a hardness of at 75-90 Shore A, and said room-temperature-curable material has a hardness of 80-95 Shore A.

28. The kit as recited in claim 25, wherein said third portion has a flexural modulus at least approximately five times the flexural modulus of said first material.

29. The kit as recited in claim 25, wherein said first and second materials have elongations at least approximately equal to 400%.

30. The kit as recited in claim 25, wherein said room-temperature-curable material has an elongation at least approximately equal to 600%.

31. The kit as recited in claim 25, wherein extra said room-temperature-curable material is applied between said user's front teeth and said inner fitting layer for additional support in holding the device securely in position.

32. The kit as recited in claim 25, wherein extra said room-temperature-curable material is applied in the vacant spaces between the said user's missing teeth to enhance the fit by functioning as a male portion of a mechanical fastening device.

33. The kit as recited in claim 25, wherein extra said room-temperature-curable material is applied in the vacant spaces between the said user's missing teeth to serve as a spacer to keep teeth from shifting.
